(19) United States
(12) Patent Application Publication
(10) Pub. No.: US 2012/0074691 A1
(43) Pub. Date: Mar. 29, 2012

(54) HIGH PRESSURE MAKE AND BREAK FLUIDIC SEAL SYSTEM

(76) Inventor: DANIEL L. BANTZ, Brookline, NH (US)

(21) Appl. No.: 12/888,501

(22) Filed: Sep. 23, 2010

(51) Int. Cl. F16L 25/00

(52) U.S. Cl. 285/332

(57) ABSTRACT

A seal system is provided for pressurized, automated, make and break, fluidic connections utilizing a male member configured to with an end portion formed to allow the male member to be inserted into a female member in a position offset from the central axis of a recess in the female member while retaining its sealing capabilities.

### CROSS-REFERENCE TO RELATED CASES

This application is a continuation of International Patent Application No. PCT/US2008/005802, which claims the benefit of U.S. Provisional Application Ser. No. 60/917,084; filed May 10, 2007, which is herein incorporated by reference.

### TECHNICAL FIELD

The present invention relates to pressurized fluidic networks, and more particularly to tubular connections for such systems that are particularly useful for automated make and break seals in a robust manner that enables sealing even when the elements of the system are offset.

### BACKGROUND

It is sometimes desirable to perform moderate- to high-pressure (hundreds of psi to 10,000 psi), automated (i.e. on robotic type systems via robotic type mechanisms), on-the-fly, make and break, fluidic connections between two elements in a system or device. For example, it is common for automated injection systems to transport samples to an injection valve used for introducing samples into an analytical system. These injections into the valve can generate up to hundreds of psi pressure. In this case, it is highly impractical to use distribution valves or manifolds plumbed to the injection valve since the application generally requires positional flexibility for the samples and the dead and change-over volumes implicit in that type of design would require unacceptably large sample volumes wasting precious sample material. Also, the additional valves, pumps, and plumbing required to adequately clean all the ports and channels in such a system would drive the cost and complexity to a point beyond what the market would bear. Another example where moderate- to high-pressure, automated, on-the-fly, make and break, fluidic connections provide a benefit is where a fluid or fluids need to be delivered to locations about a robotic deck as part of a moderate- to high-pressure fluidic network and any connecting line or port volumes or contamination between the fluid source and destination points cannot be tolerated. In this case, it is desirable to directly, yet reversibly, connect the fluid source to the destination point with minimal or no intervening tubing, ports, or channels.

Several forms of automation-friendly, make and break, tubular fluidic connections exist in the market today. In general, these connections can be broken down into the type of seal employed and the mechanism for generating or maintaining the sealing pressure. Typical types of seals include: face seal, side seal, and dissimilar beveled wedge or interference seal while types of sealing pressure generation/maintenance include: quarter-turn (e.g. Luer), ball or pin and detent, side surface to side surface friction fit, and electrical or pneumatic actuation devices.

Dissimilar beveled wedge or interference seal systems 110, as shown in FIG. 1 comprising a male member 120 having a tapered conical end portion 122 and a female member 130 having a conical lead-in recess 132 opening to a cylindrical inlet portion 134, are reasonably insensitive to slight variations in the radial dimensions and conical recess angles of the two mating surfaces as long as the shapes of the two pieces remain the same. An adequate seal will generally form if one or both of the pieces is/are slightly larger, smaller, or has/have a slight variation in its/their cone angle(s). The seal might form lower down or higher up along the tubular axis depending on the direction of the variation, but the seal will generally form. Also, the sealing surface is typically very small, depending on the difference between the angles of the conical portions of the mating parts, and thus requires very little force to generate and maintain the seal. Another advantage of the interference seal is that as they will continue to seal as the mating surfaces wear. The seal will form lower down along the tubular axis as one or both of the surfaces wears but the seal will generally form.

A problem with dissimilar beveled wedge or interference seals is that the piece forming the inner part of the seal generally protrudes axially beyond the actual seal area. This results in eddy areas behind the outlet of the inner piece and in front of the seal. The longer the protrusion is past the seal surface, the larger the eddy volume and the more significant the potential fluid to fluid memory effect.

Accordingly, there is a need in the art for a seal system that overcomes at least one of the problems identified in the prior art.

### SUMMARY

A particular embodiment of the invention provides a seal system for pressurized, automated, make and break, fluidic connections comprising: a male member comprising a generally cylindrical tubular portion and an end portion extending from the tubular portion, an exterior surface of the end portion formed as a truncated curved surface converging radially inward from an outer diameter of the tubular portion; and a female member having a conical recess formed at a recess angle; the exterior surface of the end portion of the male member forming a seal with the conical recess of the female member when the male member is inserted into the female member, the seal being formed even when a cylindrical axis of the male member is offset from a conical axis of the female member at an offset angle, the available offset angle being at least about half the angle of the conical recess.

A particular embodiment of the invention provides a seal system comprising a male syringe member comprising a generally cylindrical tubular portion and an end portion extending from the tubular portion, an exterior surface of the end portion at least partially formed as a bulbous contour, the bulbous contour having a diameter greater than a diameter of the tubular portion; a female member having a conical recess formed a recess angle; the exterior surface of the bulbous contoured end portion of the male member forming a seal with the conical recess of the female member when the male member is inserted into the female member, the seal being formed even when a cylindrical axis of the male member is offset from a conical axis of the female member at an offset angle.

A particular embodiment of the invention provides a seal system comprising: a male syringe member comprising a generally cylindrical portion and an end portion, at least a portion of an exterior surface of the end portion formed having a diameter larger than a diameter of the cylindrical portion of the male member, a female member having a conical recess formed at a recess angle; the exterior surface of the end portion of the male member forming a seal with the conical recess of the female member when the male member is inserted into the female member; wherein the seal is formed even when a cylindrical axis of the male member is offset from a conical axis of the female member at an offset angle.

These and other advantages will be apparent upon review of the accompanying drawings and detailed description of the drawings discussed below.

### BRIEF DESCRIPTION OF THE DRAWINGS

Embodiments of this invention will now be described in further detail with reference to the accompanying drawings, in which:

FIG. 1 is a side sectional view of a prior art beveled wedge seal;

FIG. 2A is a side sectional view of a male member,

FIG. 2B is a representation of a female member,

FIG. 2C is a representation of the male member of FIG. 2A and the female member of FIG. 2B in a sealed position in accordance with an embodiment of the invention;

FIG. 3A is a side sectional view of the male member of FIG. 2A and the female member of FIG. 2B in a sealed position wherein the cylindrical axis of the male member is angled from the conical axis of the female member,

FIG. 3B is a detail view of the sealing interface portion of FIG. 3A;

FIG. 4A shows another embodiment of a male member in accordance with the present invention;

FIG. 4B is a side sectional view of the male member of FIG. 4A and the female member of FIG. 2B in a sealed position wherein the cylindrical axis of the male member is angled from the conical axis of the female member; and

FIG. 4C shows another embodiment of the end portion of a male member in accordance with the present invention; and

FIG. 5A is a sectional view of another embodiment of the invention showing a small diameter male member in a female member in a 6-port 2 position switching valve; and

FIG. 5B is a large diameter male member in a female member in a 6-port 2 position switching valve.

### DETAILED DESCRIPTION OF THE DRAWINGS

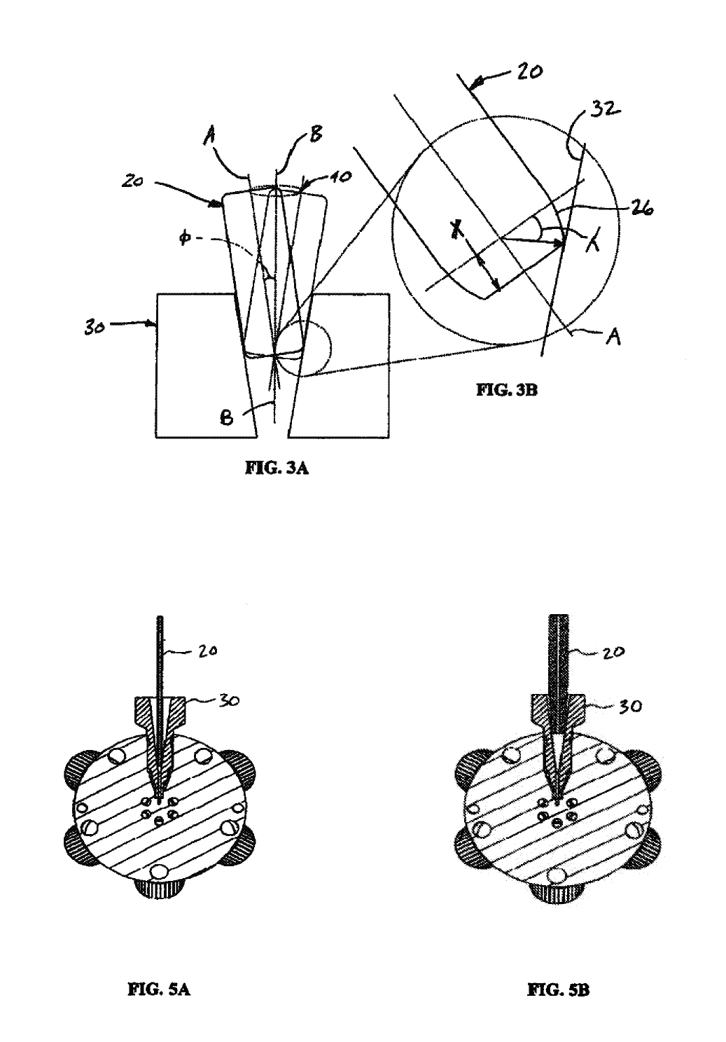

An embodiment of the seal system 10 for pressurized, automated, make and break, fluidic connections is shown generally in FIGS. 2A-2C including a male member 20 having a generally cylindrical tubular portion 22 and an end portion 24 extending from the tubular portion 22, an exterior surface of the end portion 24 formed as a truncated curved surface 26 converging radially inward from an outer diameter of the tubular portion 22. The system 10 also includes a female member 30 having a conical recess 32 at a recess angle θ. The exterior surface of the end portion 24 of the male member 20 forms a seal with the conical recess 32 of the female member 30 when the male member 20 is inserted into the female member 30.

In these fast automated systems, it is an advantage to allow some offset between the axis of the members 20, 30 while retaining the ability of the members to form a seal. The truncated external end radius 26 of the end portion 24 is able to create the seal with the internal aspect of the female element 30 as best shown in FIGS. 3A and 3B. As shown, the offset of the axis A of the male member with the axis B of the conical recess 32 of the female member 30 allows an offset angle φ which, when rotated 360 degrees, defines a procession cone 40 having an angle of twice the offset angle φ, which represents the available offset that will still result in a sealed system, the offset angle φ generally corresponds to or is slightly less than the recess angle θ of the female member 30.

The seal system 10 greatly reduces the criticality of the alignment between the male 20 and female 30 portions allowing the automation system used to make and break the seal to be much less costly and complicated. In one embodiment of the invention, this benefit is achieved by making the end radius curvature 26 of the male element 20 more severe than the angle of the internal aspect of the female portion 30.

Truncating the end radius 26 at the tip of the male unit 20 minimizes any eddy volumes formed between the tip 24 of the male unit 20 and the seal location formed with the female unit 30. In one embodiment, a minimal axial length X of the end radius 26 should be maintained in order to realize the precession feature. Specifically, this length X should minimally be long enough to support an angle greater than or equal to the offset angle φ where the angle being formed is between the axis through the initiation of end radius and a line originating from the intersection of the male unit's axial center line A and the axis through the initiation of end radius 26 and extending to the end of tip as illustrated in FIG. 3B.

The embodiment shown is in contrast to prior art dissimilar wedge or interference sealing devices where the exterior profile of the male portion forms a cone along its long axis resulting in relatively large eddy volumes between the tip of the male unit and the seal formed with the female unit. The cone shaped prior art male unit also precludes allowing any kind of precession capability of the male unit about the assembly's long axis since any non-coaxial alignment of the male and female units in this case will result in the seating of an apparent ellipse shaped male unit into the circular seat of the female unit.

The male portion 20 of the seal assembly 10 can be a discrete component permanently or reversibly affixed to the surrounding system to which it belongs (e.g. a cannula permanently or reversibly attached to a syringe pump) or it can be an integral part of the system (e.g. a machined or molded nipple on a large, complicated manifold array). The end radius 26 is tighter than the conical recess angle θ of its mating female portion.

In one embodiment of the invention, the female portion 30 of the apparatus contains a gentle inclusive recess angle θ along its interior (i.e. on its ID) aspect as shown in FIG. 2B. In one embodiment, the angle θ is in the closed interval [11°, 15° ]. This range provides adequate convergence along the female unit's interior length to form a proper seal with the male unit and provides the precession feature and subsequent misalignment tolerance of the apparatus.

This interval is not critical. Any appropriate interval that provide adequate seal and precession offset can be used. For example, the interval could also be [8°, 25° ] or any other adequate interval. Providing a conical recess angle along the long axis permits seals to be made with male units of differing tubular diameters offering great flexibility in system deployment as seen in FIGS. 5A and 5B. Applications in which this is particularly beneficial are those where connection to connection fluid memory (carry-over) is highly detrimental. Utilizing the design described herein in these applications permits forming a seal deep down in the female unit's cone with a small diameter male unit to deliver the working solution(s) (FIG. 5A) followed by forming a seal much higher up in the female unit's cone with a large diameter male unit to flow cleaning solution (FIG. 5B). The cleaning solution is delivered well above where the working solution could ever come in contact with the female unit's wetted surfaces thus completely washing out all traces of the working fluid. In addition, the cleaning solution's large diameter male unit never comes in contact with any surface that might have been contaminated by the working solution thus keeping it clean and uncontaminated throughout.

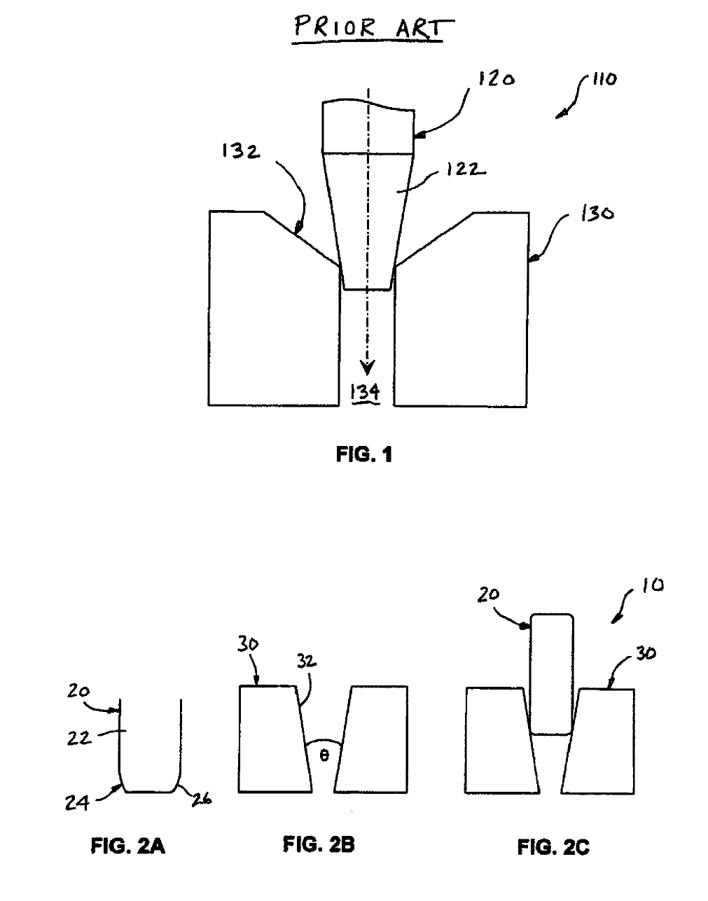

This is in contrast to other prior art dissimilar wedge or interference sealing devices where the interior profile of the female portion forms either 1) a sharp/steep cone angle or 2) a ledge (with no cone angle) formed by a ninety degree (90°) edge as illustrated in FIG. 1. Both preclude allowing any kind of precession capability of the male unit about the main axis and the latter precludes accepting male units with different tubular diameters as well.

One embodiment of this device is comprised of a monolithic fitting that reversibly affixes to fluidic ports or channels (such as switching valve ports/channels) to form the female side of the high-pressure make and break seal. Specifically, the end of the fitting that protrudes into the port/channel is designed to bottom out in the port/channel and create a zero dead volume face seal with the face of the port/channel itself as shown in FIGS. 5A and 5B. This is in contrast to prior art high-pressure ferrules and nuts used to connect tubing or side seal make and break sleeves to the port/channel. In the latter, the sealing forces are designed to compress the ferrule around the tubing or sleeve approximately one millimeter up from the actual port/channel face creating a potential eddy volume within the ferrule to tubing to port interface wherein contaminants can accumulate causing fluid to fluid memory from one seal event to another.

Creating the female side of the sealing device as a discrete, monolithic, reversibly affixed fitting allows for creation of a universal, zero dead volume face seal feature at the port/channel interface for the device while still allowing many different diameters for the male side of the assembly (FIGS. 5A and 5B). Alternatively, for port/channel inlet geometries that differ substantially from each other, the port/channel detail of the female unit can be made specific to those geometries while still allowing a wide range of diameters in the male make and break portion of the apparatus. The fitting's port/channel geometry is all that would need to be customized for the different port/channels to utilize the benefits of this high pressure, make and break fluidic seal assembly 10.

One unit forms the female side 30 of the connection while the other unit forms the male side 20 not unlike existing make and break fluidic sealing systems. Features conferring unique advantages to this design lie in the specific geometry of the interior and exterior aspect of the female unit and the exterior aspect of the male unit as well as in the surface preparation of the interior aspect of both units. The system 10 is insensitive to specific inner or outer diameters of the two units as well as the actual diameter of the continuous flow path formed by their union with the following notable exceptions. 1) The outer diameter of the male unit must be consistent with some portion of the inner diameter of the female unit but their absolute diameters are immaterial. 2) The wall thickness and material selection between the inner and outer walls of both units must safely support the rated seal pressure. And, 3) the axial force holding the two units together must be sufficiently high to withstand the rated seal pressure but without being too high so as to compromise the structural integrity of either of the two units.

Either or both units 20, 30 can be fully integrated parts of the surrounding system in which they are situated. For example, the geometry defining the male unit 20 can be machined or molded directly into the end of a length of tubing or other substrate (e.g. manifold) used to deliver fluid to or receive fluid from the female unit. Likewise, the geometry defining the female unit 30 can be machined or molded directly into the end of a length of tubing or other substrate (e.g. manifold or fluidic port) used to deliver fluid to or receive fluid from the male unit. Alternatively, either or both units 20, 30 can be discrete components that are otherwise permanently or reversibly affixed to their respective sides of the fluidic path. For example, the male unit 20 could be a discrete metal cannula that gets affixed to a syringe for use while the female unit 30 could be a discrete fitting that gets affixed to a port in a fluidic valve for use.

The surface finish of the wetted aspects of both sealing surfaces is important in applications where eliminating connection to connection fluidic contamination is of paramount importance. One embodiment of this invention calls for a surface finish of 16 microinches or better to minimize molecular adhesion to the device's wetted surfaces. This specification is relaxed for embodiments used in less contaminant sensitive applications. Alternatively or additionally, either or both units can be created from or coated with inert materials to further reduce molecular adhesion to the wetted surfaces.

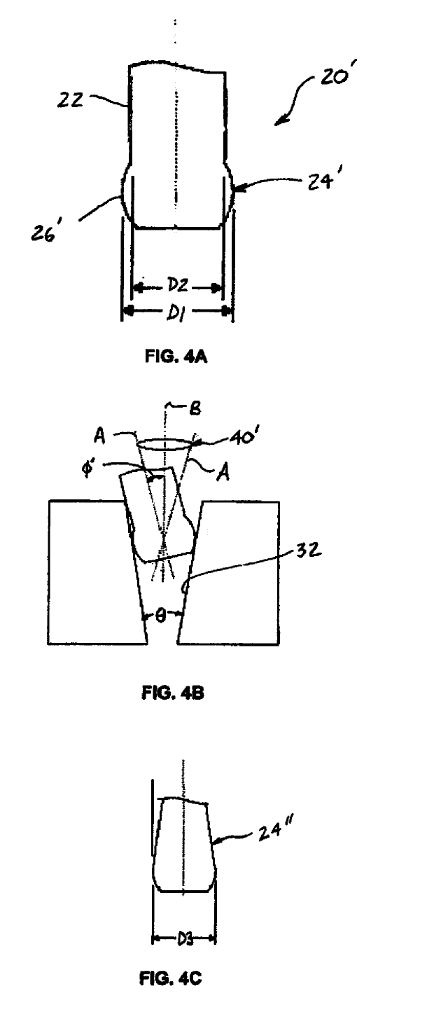

Referring now to FIGS. 4A-4B, another embodiment of the invention is shown. The male member 20′ has an end portion 24′ extending from the tubular portion 22, an exterior surface of the end portion 24′ at least partially formed as a bulbous contour 26′, the bulbous contour 26′ having a diameter D1 greater than a diameter D2 of the tubular portion 22. The result of the configuration of the male member 20′ is a larger offset than available with the previous embodiment while maintaining sealing capability as shown in FIG. 4B. As shown, the offset of the axis A of the male member with the axis B of the conical recess 32 of the female member 30 allows an offset angle φ which, when rotated 360 degrees, defines a procession cone 40′ having an angle of twice the offset angle φ′, which represents the available offset that will still result in a sealed system, twice the offset angle φ′ generally corresponds to or is greater than the recess angle θ of the female member 30.

Another embodiment is shown in FIG. 4C which has an end portion 24″ which has a similar profile as the previous embodiment from the point of the large diameter D1 to the end of the tip, but in the other direction from the diameter, depicted in FIG. 4C as diameter D3, the end portion 24″ tapers inwardly along at least a portion of the male member 20″ moving away from the tip of the member 20″. As with the previous embodiment, the result will be that when the male member 20″ is used with female member 30 (not shown), a larger offset angle will be available such that twice the offset angle is larger than the recess angle θ of the female member 30 (not shown).

A seal system suitable for moderate to high pressure, automated, make and break fluidic connections has described with reference to the foregoing description, figures, and embodiments. It is appreciated that modifications may occur to persons skilled in the art upon reading and understanding the specification and annex drawings. It is intended that the inventive subject matter be considered as including all such modifications insofar as they come within the scope of the appended claims or equivalents thereof.

What is claimed is:

1. An automated, pressurized, make and break fluidic connection system comprising: a male member comprising a generally cylindrical tubular portion and an end portion extending from the tubular portion, an exterior surface of the end portion formed as a truncated curved surface tangent to and converging radially inward from an outer diameter of the tubular portion; and
a female member having a conical recess formed at a recess angle;
the male member insertable into the female member at an angle offset from a the conical axis of the female member, the offset angle being up to half the angle of the conical recess;
the exterior surface of the end portion of the male member forming a seal with the conical recess of the female member when the male member is inserted into the female member.

2. The system of claim 1, wherein the exterior of the end portion is formed in a longitudinally axial cross-section as a radius.

3. The system of claim 1, wherein the diameter of the end of the male member is larger than the diameter of the cylindrical portion of the male member.

4. The system of claim 1, wherein at least a portion of the male member is tapered between the cylindrical portion and the end portion of the male member.

5. The system of claim 4, wherein at least one diameter of the tapered portion is smaller than a diameter of the largest portion of the end portion of the male member.

6. The system of claim 1, wherein the available offset angle is greater than half of the angle of the conical recess.

7. The system of claim 1, wherein the angle of the conical recess is in the range of 11-15 degrees inclusive.

8. The system of claim 1, wherein the angle of the conical recess is in the range of 8-25 degrees inclusive.

9. The system of claim 1, wherein the surface finish of the female member and male member have a surface finish of 16 microinches or smoother at least at a portion of each member that contacts the other member.

10. The system of claim 1, wherein the material of the male member is harder than the female member.

11. The system of claim 2, wherein the radius of the exterior of the end portion is smaller than an inner diameter formed at a leading end of the conical recess of the female member.

12. The system of claim 1, wherein the female member is formed as a discrete, monolithic, reversibly affixed fitting.

13. An automated, pressurized, make and break fluidic connection system comprising:
a male syringe member comprising a generally cylindrical tubular portion and an end portion extending from the tubular portion, an exterior surface of the end portion at least partially formed as a bulbous contour, the bulbous contour having a diameter greater than a diameter of the tubular portion;
a female member having a conical recess formed a recess angle;
the male member insertable into the female member at an angle offset from a the conical axis of the female member, the offset angle being up to an angle greater than half the angle of the conical recess;
the exterior surface of the bulbous contoured end portion of the male member forming a seal with the conical recess of the female member when the male member is inserted into the female member.

14. The system of claim 13, wherein the angle of the conical recess is in the range of 11-15 degrees inclusive.

15. The system of claim 13, wherein the angle of the conical recess is in the range of 8-25 degrees inclusive.

16. An automated, pressurized, make and break fluidic connection system comprising:
a male syringe member comprising a generally cylindrical portion and an end portion, at least a portion of an exterior surface of the end portion formed having a diameter larger than a diameter of the cylindrical portion of the male member;
a female member having a conical recess formed at a recess angle;
the male member insertable into the female member at an angle offset from a the conical axis of the female member, the offset angle being up to an angle greater than half the angle of the conical recess;
the exterior surface of the end portion of the male member forming a seal with the conical recess of the female member when the male member is inserted into the female member.

17. The system of claim 16, wherein at least a portion of the male member is tapered between the cylindrical portion and the end portion of the male member.

18. The system of claim 17, wherein at least one diameter of the tapered portion is smaller than a diameter of the largest portion of the end portion of the male member.
